(19) United States
(12) Patent Application Publication
(10) Pub. No.: US 2003/0182802 A1
(43) Pub. Date: Oct. 2, 2003

(54) V-shaped razor head and blades

(76) Inventors: Hugo Vega, Buenos Aires (AR); Edgardo Van Rhyn, Weston, FL (US)

Correspondence Address: Patent Law Offices of, Heath W. Hoglund, 256 Eleanor Roosevelt, San Juan, PR, 00918, US

(21) Appl. No.: 10/108,977

(22) Filed: Mar. 28, 2002

(51) Int. Cl. B26B 21/52

(52) U.S. Cl. 30/50; 30/527

(57) ABSTRACT

A razor includes a v-shaped head, a plurality of v-shaped blades and a handle. The left and right sides of the v-shaped blades meet at approximately one-hundred and twenty degrees. The bottom of the v-shaped blade is rounded. When configured in a package, the bottom of one v-shaped head fits within a valley defined by another v-shaped head.

### FIELD OF INVENTION

The invention relates generally to razors and more particularly to the configuration of razor heads and blades.

### BACKGROUND OF THE INVENTION

Disposable shaving instruments are commonly used and known by just about everyone. These instruments generally include a plastic head attached to the top of a plastic handle. This plastic head typically includes one or more blades aligned horizontally on the longitudinal axis of the plastic handle. The blade edges cut through hairs perpendicularly at the predetermined cutting angle at which the blades have been manufactured. The individual hairs are then cut by forcing the sharpened edge of the blade through the hairs. This, in turn, causes all hairs to be pulled in response to the force of the cutting action. This action of the hairs being pulled may cause uneven shaving, cuts, and even infections. Because of this, attempts have been made to soften the hairs to be shaved, by adding shaving creams, gels and lotions. This makes the shaving process more comfortable and helps to achieve a smoother, closer shave.

Some alterations have also been made to actual blades. For example, U.S. Pat. No. 4,663,843, issued May 12, 1987, by Savage, teaches a razor having at least one leading blade where the edges are inclined diagonally relative to the longitudinal axis of the handle. The razor also contains a horizontally aligned trailing blade that can be used for trimming side burns and under the nose. By positioning the leading blade at an incline, that blade meets any hairs at an angle and slices more smoothly through the same.

Many other razor blades have also been made to try and make the shaving process more comfortable. Some examples are: flexible blade heads that adjust to the unevenness of the skin, having more than one blade on the razor head, and even adding a small amount of aloe trailing behind the blades to make the process less uncomfortable.

### SUMMARY OF THE INVENTION

According to one aspect of the invention, a razor includes a handle and v-shaped head. The v-shaped head houses a pair of v-shaped razors. The cutting surfaces of the v-shaped razors are arranged in parallel so that during the action of shaving a leading blade slices any hairs at an angle and is immediately followed by the trailing blade at that same angle. This combination of angled blades provides a smoother cutting action.

According to another aspect of the invention, the v-shaped head is configured to fit snugly against a matching v-shaped head. This helps to improve packing density of the product.

According to another aspect of the invention, a razor includes a v-shaped head having a right and a left side joined at an angle of approximately one-hundred and twenty degrees. Both the right and the left side include a leading and a trailing member. The razor also includes two v-shaped blades each having a cutting edge with a right and a left side, which are also joined at an angle of approximately one-hundred and twenty degrees. The right and left side of the cutting edge define a substantially linear edge. The joint between the right and left sides of the cutting edge defines a curved edge. The v-shaped blades are positioned between the leading and trailing member of the v-shaped head so that one defines a passage way with the leading edge and the other defines a passage way with the trailing edge. Another passage way is defined between the two v-shaped blades. This provides a path for shaving cream and hairs to pass from the front to the back side of the v-shaped head. The cutting edges on the right side of the v-shaped blades lie substantially parallel. Likewise, the cutting edges on the left side of the v-shaped blades lie substantially parallel. The razor also includes a handle having a grip end and an attachment end pivotably coupled with the v-shaped a head. The attachment end may grip or release the v-shaped head. The razor also includes a pair of structural members positioned midway along the right and left side of the v-shaped head. The structural members connect with the leading and trailing members at an angle of approximately ninety degrees. A package of these razors is configured so that the point of the v-shaped head, or apex, of one razor fits within the valley defined between the trailing member of the v-shaped head of another razor.

According to another aspect of the invention, a razor includes a handle, a v-shaped head and a plurality of blades. The handle has an attachment end and a grip end. The v-shaped head is coupled with the attachment end of the handle. The plurality of parallel blades are embedded in the v-shaped head. The plurality of blades form a plurality of v-shaped cutting surfaces where the joint between the two arms of the v-shaped cutting surfaces are curved.

According to another aspect of the invention, a plurality of razor heads are arranged in a tray that defines a plurality of v-shaped compartments. Each razor head has a left and a right member that meet at an angle less than one-hundred and eighty degrees. A leading edge of the razor head defines an apex and a trailing edge of the razor head defines a valley. The razor heads are arranged in the tray so that the apex of one body fits within the valley of another body.

According to another aspect of the invention, a razor package includes a plurality of v-shaped razor heads. The v-shaped razor heads are arranged so that one v-shaped razor head fits within the valley defined by another v-shaped razor head. A handle extends from each v-shaped razor head. The handles are substantially parallel to one another.

According to another aspect of the invention, a package of razors includes an anterior and a posterior side joined by a side wall. The posterior side defines a first slot. The side wall defines a second slot proximate the anterior side. A plurality of v-shaped razor heads extend through the second slot. A plastic handle extends from each v-shaped razor head through the first slot.

### DESCRIPTION OF DRAWINGS

FIGS. 1A, 1B, 1C, and 1D are views of one preferred razor including a body and a head. FIG. 1A is a side view, FIG. 1B is a front view, FIG. 1C is a back view, and FIG. 1D is a perspective view.

FIG. 2 is a top view of the razor head of FIGS. 1A-1D.

FIG. 3 is a cross sectional view of the razor head, including leading and trailing blades, taken along lines 3-3 of FIG. 2.

FIG. 4 is a top view of one preferred razor head tray and associated razor heads.

FIG. 5 is a front view showing one preferred packaging configuration for a group of razors.

FIG. 6A is a side view of another preferred packaging configuration for a group of razors.

FIG. 6B is a back side view of the package of FIG. 6A shown without the group of razors.

### DETAILED DESCRIPTION

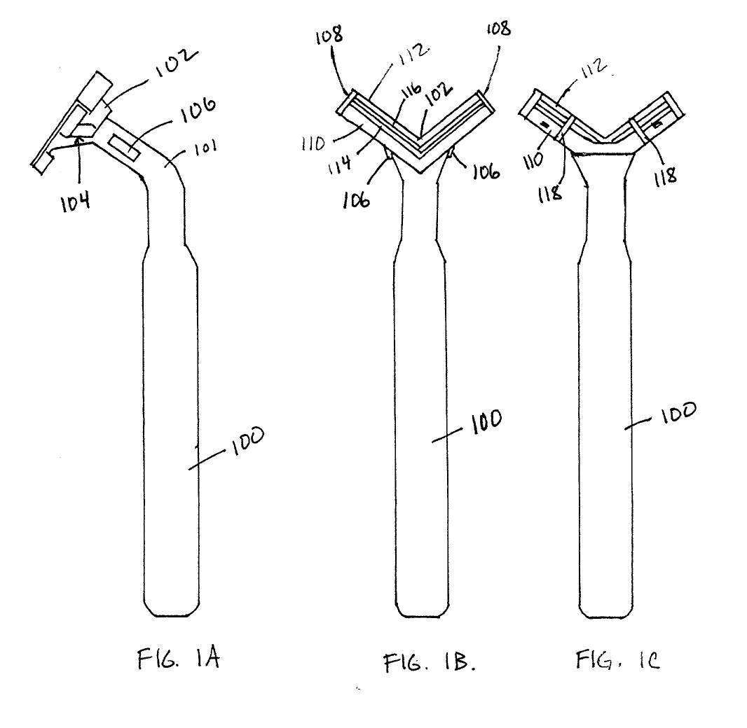

Turning to FIG. 1A, one preferred razor is described. The body of the razor has the shape of a regular razor. There is a handle 100 which is wider than the neck of the razor 101 in order to provide a better grip and more stability while shaving. On both sides of the neck of the razor 101 are release buttons 106 (shown in FIGS. 1A and B); there is one on the right side and one on the left side, just below the razor head 102 and on the end of the razor neck 101. These buttons 106 are used to release the razor head 102 when it is no longer useful because the blades dull and a new razor head can be attached. These release buttons control the attachment mechanism 104 (FIGS. 1A and 1D), which is located between the razor handle 100 and the razor head 102. This attachment mechanism 104 has teeth-like structures with evenly spaced gaps in between. These gaps that are found between the teeth of the attachment mechanism 104 are compatible with smaller protrusions found on the razor head 102 that snap into the gaps so the razor head 102 becomes attached to the razor handle 100. When the release buttons 106 are pressed in, the teeth in the attachment mechanism spread a little further apart making the gaps slightly wider, thus releasing the grip on the razor head 102. Such attachment mechanisms, including a wide variety of different configurations, are well known by those skilled in the art.

Turning to FIG. 1B another view of the razor head 102 is described. The bottom part of the v-shaped razor head 102 is the leading member 110, or the part that first comes in contact with the area to be shaved. The top of the v-shaped razor head 102 is the trailing member 112, or the part that last comes in contact with the area to be shaved. Both the leading member 110 and the trailing member 112 are made of plastic which has been formed into a v-shape. The leading member 110 initiates the shaving process and guides the razor head through the area that is to be shaved. The razor blades are located in between the leading member 110 and the trailing member 112.

The first blade after the leading member 110 is the leading razor blade 114. The leading razor blade 114 is located on the razor head 102 in such a way that one leading cutting surface is located on the right side of the razor head 102 and one leading cutting surface is located on the left side of the razor head 102. The two leading cutting surfaces come together in the middle of the razor head 102 at angles, which form a v-shape. As the two cutting surfaces on opposing sides come together at an angle, the junction between them is rounded at the bottom corner. This provides a smooth, continuous cutting surface, which facilitates a smooth shave.

After the leading razor blade 114, comes the trailing razor blade 116, just before the trailing member 112. The trailing razor blade 116 is on the razor head 102 in such a way that one trailing cutting surface is located on the right side of the razor head 102 and one trailing cutting surface is located on the left side of the razor head 102. The two trailing cutting surfaces also come together is the middle of the razor head 102 forming a v-shape with a rounded bottom. The shape of the trailing razor blade 116 matches that of the leading razor blade 114, and their respective cutting surfaces are arranged in parallel. As the leading razor blade 114 slices hairs at an angle, it is immediately followed by the trailing razor blade 116, which repeats the angled slicing action. Preferably, the cutting surfaces are positioned at a thirty degree angle so that they strike hairs at that same angle as the razor is pulled across the skin.

The v-shape of the leading member 110 and the v-shape of the trailing member 112 are configured at the same angle as the cutting surfaces of the razor blades, and are also rounded along the bottom of the v-shape. As the razor head 102 is drawn across the skin, the leading and trailing members help to keep a constant distance and/or pressure between the skin and the cutting surfaces.

Of course, although the razor head 102 has been described with two v-shaped razor blades, additional blades may be added. For example, a three-blade model would also operate satisfactorily.

Turning to FIG. 1C, a back view of the razor head can be observed. In the back view of the razor head, structural members 118 can be found. These structural members 118 are located on the back of the razor head 102 on opposite sides of the razor head 102 at opposing angles. One structural member is located on the right side of the razor head 102 (as seen from the back in FIG. 1D) at an angle moving diagonally from left to right, seen from top to bottom. The other structural member is located on the left side of the razor head at an angle moving diagonally from right to left, seen from top to bottom. These structural members hold the right and left side of the razor head together, giving each side strength and structure. The structural members 118 make it possible for the razor head 102 to maintain the v-shape and still have enough support in order to withhold the force placed upon it during shaving. Preferably, the structural members 118 meet the leading member 110 and the trailing member 112 at a right angle. Thus, where the arms of the leading member 110 form a thirty degree angle from horizontal, the structural members 118 form a one-hundred and twenty degree angle from horizontal.

In reference to FIG. 1D, there are end caps 108 found at the end of each side of the razor head 102. One is found on the edge of the right side and one is found on the edge of the left side. These end caps 108 are made of plastic and are small rectangular caps that protect the right and left edges of the v-shaped razor head. They give the razor head a finished look. They also prevent someone from cutting themselves with the edge of the razor head, as the razor blades end just before the end caps 108.

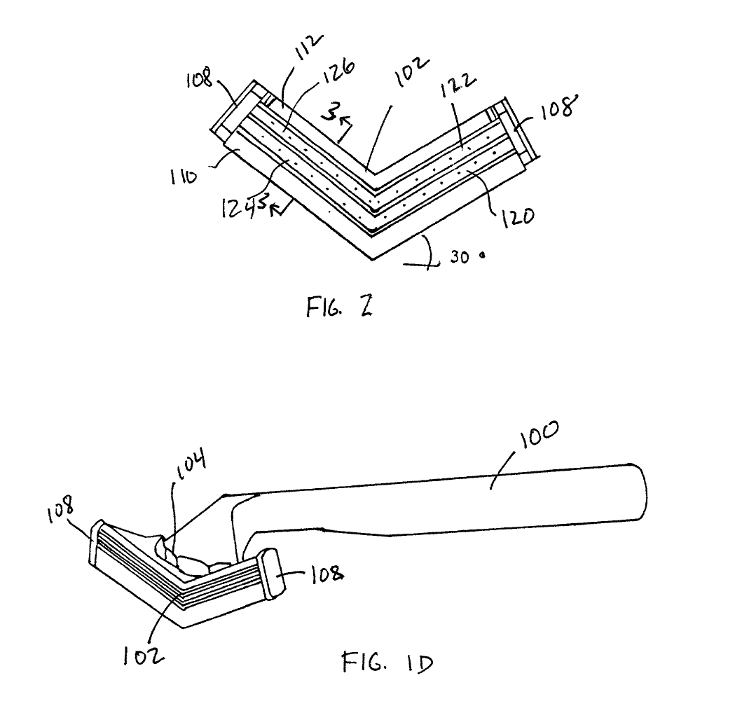

Turning to FIG. 2, the v-shaped razor head 102 is further described. On the edges the end caps 108 are found. Then starting from the bottom and working towards the top of the v-shaped razor head there is the leading member 110. Then there is the right leading edge 120 and the right trailing edge 122 found on the right side of the razor head, and the left leading edge 124 and the left trailing edge 126 found on the left side of the razor head. Finally, the razor head ends with the trailing member 112.

The razor head 102 itself has a v-shape that is formed by the leading member 110, the leading and trailing blades 114 and 116, and the trailing member 112. In FIG. 2, the arms of the razor head 102 meet at a 120° as do the component elements.

In reference to FIG. 2, the right and left side of the razor head each have leading and trailing razor edges that come together and form the leading and trailing razor blade. On the right side there is the right leading edge 120 and on the left side there is the left leading edge 124. These two leading edges come together at a 120° with a slightly rounded bottom edge, to form the v-shaped leading razor blade on the razor head. This v-shape is designed to cut hair along an angle, resulting in a smoother shave. As the v-shape is drawn along the surface of the skin, the blades on either side meet the hair at an angle. This angled cut provides a smoother shave.

Following the leading razor blade 114 is the trailing razor blade 116. The trailing razor blade's function is to get any hairs that escaped the leading razor blade or to reach hairs closer to the skin to provide a smoother more efficient shave with each stroke. The trailing razor blade is made up of the right trailing edge 122 on the right side of the razor head and the left trailing edge 126 on the left side of the razor head. These two leading edges come together at a 120° with a slightly rounded bottom edge, to form the v-shaped trailing razor blade on the razor head.

The actual construction of the razor head is predominantly plastic. The leading member 110 and the trailing member 112 are made of plastic. The leading member 110 is also v-shaped as the right and left sides come together. The leading member also has a rounded edge at the bottom where the two parts of both sides come together. The trailing member also has two sides, right and left that come together to form a v-shape at that same angle.

The leading and trailing edges of the blades also have a specific construction. The left leading edge 124 following the leading member 110 is a metal piece about 1.5 cm wide having the sharp edge aligned diagonally, so it can cut an angle and form the v-shape. The cutting edge of the left leading edge 124 is the side that is closest to the leading member 110. The left leading edge 124 has a blunt edge opposite the sharp edge that cuts the hair. This blunt edge is closest to the trailing edge 126. The left leading edge 124 also has a square end on the side which is closest to end cap 108. On the other side of the left leading edge 124, the side that comes in contact with the leading edge 120, the leading edge is cut off at a slant. This slant is where the leading edge on the right and left side are going to come together to form the v-shaped leading blade. The leading edge on the left side and the leading edge on the right side are constructed as mirror images so that they form a symmetrical blade.

The trailing edge 126 is constructed in the same manner as the leading edge 124. The left trailing edge 126 is alligned parallel to the left leading edge 124 and is constructed of metal about 1.5 cm in width having the sharp edge aligned diagonally so it can cut at an angle and also form the v-shape. Thus the left trailing edge 126 follows the same path as the left leading edge 124. The trailing member 112 then follows it. All components together forming one v-shaped razor head.

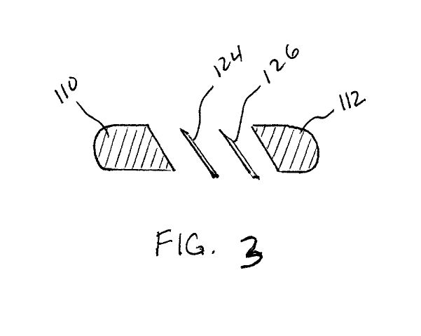

In this v-shaped razor head, adjacent the blades form parallel passageways which are shown in FIG. 3. These passageways allow hair and shaving cream to pass through from the front to the back side of the razor head so that the same does not accumulate along the cutting surfaces.

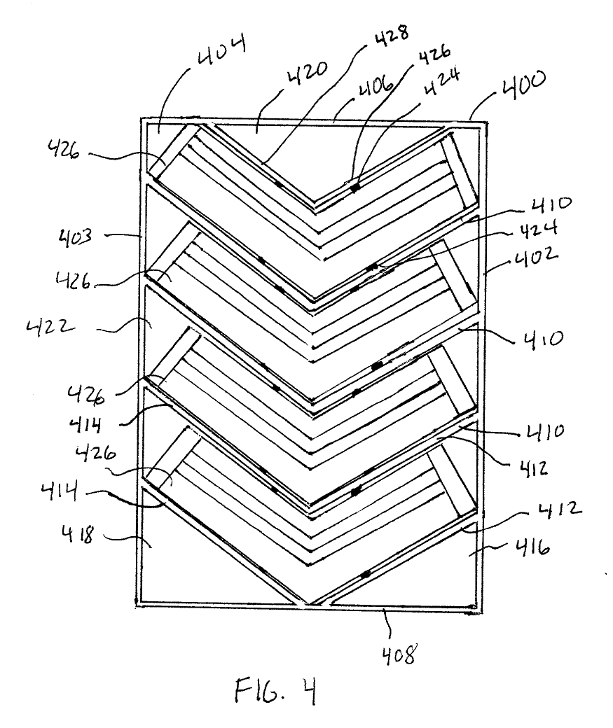

Preferably, the v-shaped razor blade heads are organized in a tray 400, which is shown in FIG. 4. The tray is rectangular having two long side walls 402 and 403 and a top wall 406 and a lower wall 408. These walls give the tray its sturdiness. In between the four walls is the actual tray having a plastic bottom 404 where the razor heads will rest.

Inside, the tray has v-shaped compartments 422 that are made to hold the v-shaped razor heads 426 in place. Each v-shaped compartment 422 is defined by an and a lower v-shaped wall 410. Starting from the lower wall 408 of the tray and moving up, the v-shaped compartments are outlined so that the right wall 412 of the v-shaped compartment and the left wall 414 of the v-shaped compartment define the bottom v-shape of the compartment. The right wall 412 is a diagonal starting about one fifth of the way up the right side wall 402 and reaching the halfway point on the lower wall 408. The left wall 414 is a diagonal starting about one fifth of the way up the left side wall 403 and reaching the halfway point on the lower wall 408, forming the v-shape on the bottom wall as the right and left compartment walls come together. The sides of the v-shaped compartment are formed by the side walls 402 and 403. The top part of the v-shaped compartment is then formed by the right wall 412 and left wall 414 of the v-shaped compartment directly above it.

The other v-shaped compartments follow the same pattern until the v-shaped compartment at the top of the tray is reached. This v-shaped compartment has the top of its v-shape formed by a diagonal right wall 426 extending from the top wall 406 of the tray to the middle of the top part of the razor head, and a diagonal left wall 428 extending from the top part of the tray 406 to the same midpoint.

As both the top right wall and top left wall of the top v-shaped compartment come together they form a triangular compartment 420 at the top of the tray along with the top wall 406 of the tray. An obtuse triangular compartment is formed having the top wall forming the hypotenuse and the right and left compartment walls forming the two sides of the triangle.

At the bottom of the tray there are two triangular compartments as well. The triangular compartment 418 on the left side is formed by the lower wall 408 of the tray, the left side wall 403 of the tray, and the left wall 414 of the v-shaped compartment. This triangular compartment is a right triangle. It has the left wall 414 of the v-shaped compartment forming the hypotenuse and the left side wall 403 and the lower wall 408 forming the remaining two sides of the triangle.

On the lower right side of the tray is the right triangular compartment 416. This triangular compartment is formed by the lower wall 408, the right side wall 402 and the right wall 412 of the v-shaped compartment. This is also a right triangle. The hypotenuse being formed by the right wall 412 of the v-shaped compartment and the remaining two sides being formed by the lower wall 408 and the side wall 402 located on the right side of the tray.

To insure that the v-shaped razor heads stay in place there are small protrusions 424 extending from each side of the walls 410. These protrusions press down on the v-shaped razor heads and apply a small amount of pressure over the razor heads in order to keep them in the v-shaped compartments 422. There are at least two protrusions holding each side of the v-shaped razor head 426 in place. One protrusion is found on the top of the v-shape wall 410 and one protrusion is found on the bottom. The protrusions are preferably on both the left and right side of the v-shaped compartment 422.

All the parts discussed above form the rectangular tray for holding the v-shaped heads. This keeps the replacement heads in an organized manner and easily available when needed. To remove a head, a user simply snaps a handle into the attachment mechanism of a head and pulls the head out of the tray. The head is then attached to the handle and may be used for shaving.

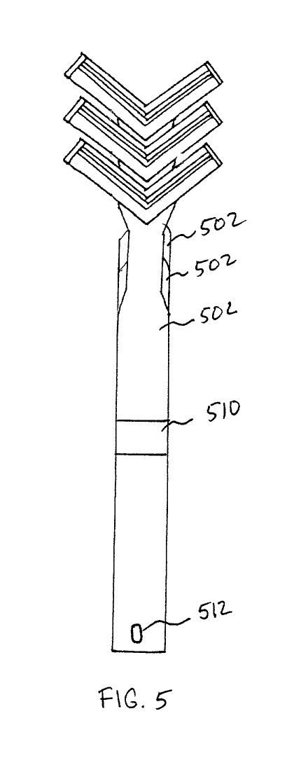

In reference to FIG. 5, another preferred set of v-shaped razors are described as configured in a package of three. The razors 502 fit closely one on top of the other because each v-shaped head fits directly into the v-shaped head of the next razor. Looking at the package from a front view, it is observed that the leading member of the second razor fits directly into trailing member of the first razor blade. This direct fit is made possible because of the v-shape of the razor heads. This forms a tight package. The handles are then held together by a band 510. At the bottom of the handle, there is a hole 512 that can be used to hang the razor on a hook for display. Each razor head preferably includes a plastic cover (not shown).

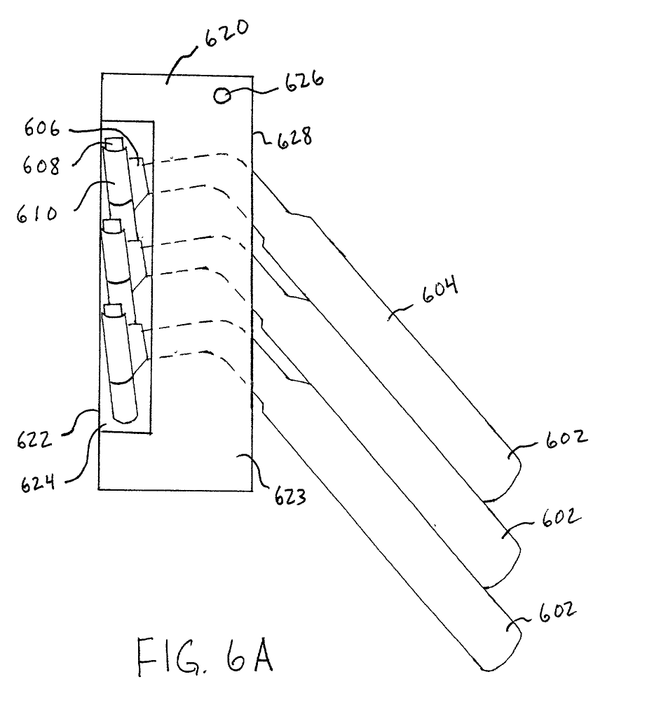

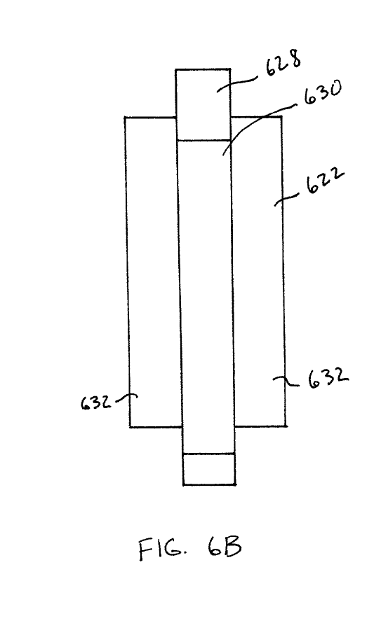

Turning to FIG. 6A, another preferred set of v-shaped razors are described as configured within a cardboard package. Each razor 604 includes a handle 602, a v-shaped head 608, a pivotal attachment 606 and a plastic cover 610. The plastic cover 610 keeps the blades on the razor head protected and free of dust and particles. The plastic cover also serves the purpose of keeping a user protected from the sharp blades. The package 620 includes a rectangular body 623, which consists of a pair of side walls, a front face 622 and a back wall 628. The body 623 defines a slot 624, which abuts the front face 622. The razor handles 602 are held between the side walls of body 623. On the front side, razor heads 608 are held back by the front face 622 and extend out the side of the package through slot 624. On the opposite side, the razor handles extend through a slot (shown in FIG. 6B) in the back wall 628. The razors are prevented from sliding out the back slot as razor heads 608 are confined along the back side of slot 624. The upper portion of body 623 defines a hole 626. This may be used to hang the package for display purposes.

Turning to FIG. 6B, the razor package of FIG. 6A is shown from the back side without any razors. Again body 623 (shown in FIG. 6A) connects the back side 628 to the front face 622. The front face 622 includes a pair of wings 632 that extend along slot 622 (shown in FIG. 6A). The front face 622 and these wings 632 hold the front side of the razor heads in place. The back wall 628 defines a slot 630 through which the razor handles 602 (shown in FIG. 6A) extend.

Although the invention has been described with reference to specific embodiments, of course those skilled in the art will appreciate that many modifications to the embodiments described herein are possible without departing from the scope of the invention. All such modifications are intended to be encompassed by the following claims.

We claim:

1. A razor comprising:
a v-shaped head having a right and a left side joined at an angle of approximately one-hundred and twenty degrees, and wherein both the right and the left side include a leading and a trailing member;
a first and a second v-shaped blade having a cutting edge with a right and a left side joined at an angle of approximately one-hundred and twenty degrees, wherein the right and left side of the cutting edge define a substantially linear edge and the joint between the right and left sides define a curved edge, and wherein the first and the second v-shaped blades are positioned between the leading and trailing member of the v-shaped head, and wherein the cutting edge on the right side of the first and second v-shaped blades lie substantially parallel, and the cutting edge on the left side of the first and second v-shaped blades lie substantially parallel;
a handle having a grip end and an attachment end pivotably coupled with the v-shaped head proximate the joint between the right and left sides along a back side of the first and second v-shaped blades.

2. The razor of claim 1, wherein the v-shaped head further comprises a right structural member positioned along the right side of the v-shaped head and connecting with the leading member at approximately a ninety degree angle and connecting with the trailing member at approximately a ninety degree angle, and a left structural member positioned along the left side of the v-shaped head and connecting with the leading member at approximately a ninety degree angle and connecting with the trailing member at approximately a ninety degree angle.

3. The razor of claim 1, wherein the first v-shaped blade defines a passage with the leading member, wherein the second v-shaped blade defines a passage with the trailing member, and wherein the first and second v-shape blades define a passage therebetween.

4. The razor of claim 1, wherein the handle further comprises a release mechanism having a first and a second positioned and configured to grip the v-shaped head in the first position and to release the v-shaped head in the second position.

5. The razor of claim 1, further comprising a plurality of razors each having the v-shaped head, the first and second v-shaped blades and the handle, and wherein each of the plurality of razors define an apex along the leading member at the joint between the right and left sides of the v-shaped head and define a valley along the trailing member between the right and left sides of the v-shaped head, and wherein the apex of one razor fits within the valley of another razor.

6. A razor comprising:
a handle having an attachment end and a grip end;
a v-shaped head coupled with the attachment end of the handle; and
a plurality of parallel blades embedded in the v-shaped head.

7. The razor of claim 6, wherein the attachment end of the handle comprises a pivotable attachment.

8. The razor of claim 7, wherein the grip end of the handle comprises a plurality of ribs.

9. The razor of claim 8, wherein the v-shaped head comprises a left member and a right member that meet at an angle of approximately 120 degrees.

10. The razor of claim 9, wherein the plurality of parallel blades comprises a first v-shaped blade having a left and a right member wherein the left member of the first v-shaped blade is embedded in the left member of the v-shaped head, and the right member of the first v-shaped blade is embedded in the right member of the v-shaped head, and wherein the left and right members of the first v-shaped blade meet at an angle of approximately 120 degrees.

11. The razor of claim 10, wherein the plurality of parallel blades further comprises a second v-shaped blade having a left and a right member wherein the left member of the second v-shaped blade is embedded in the left member of the v-shaped head, and the right member of the second v-shaped blade is embedded in the right member of the v-shaped head, and wherein the left and right members of the second v-shaped blade meet at an angle of approximately 120 degrees, and wherein the left members of the first and second v-shaped blades are substantially parallel, and the right members of the first and second v-shaped blades are substantially parallel.

12. The razor of claim 11, wherein the first v-shaped blade defines a curved surface along its cutting edge at the joint between the its left and right members, and wherein the second v-shaped blade defines a curved surface along its cutting edge at the joint between its left and right members.

13. A plurality of razor heads suitable for attachment to a shaving handle, wherein each of the razor heads comprises:
a body having a left and a right member that meet at an angle less than one-hundred and eighty degrees and wherein a leading edge of the body defines an apex and a trailing edge of the body defines a valley; and
a plurality of blades attached to the body along the left and right members, and wherein the blades along the left member are aligned parallel to each other and the blades along the right member are aligned parallel to each other, and wherein the plurality of razor heads are arranged so that the apex of one body fits within the valley of another body.

14. The plurality of razor heads of claim 13, wherein each of the blades along the left member each join one of the blades along the right member at an angle of less than one-hundred and eighty degrees, and wherein each joint between the blades along the left member and the blades along the right member define a curved cutting edge.

15. The plurality of razor heads of claim 14, wherein the angle between the blades along the left member join the respective blade along the right member at an angle of approximately one-hundred and twenty degrees.

16. The plurality of razor heads of claim 13, wherein the body further comprises an attachment mechanism substantially centered along the body between the leading and trailing edges.

17. The plurality of razor heads of claim 13 further comprising a tray having a plurality of compartments each configured to hold one of the plurality of razor heads.

18. The plurality of razor heads of claim 17, wherein the plurality of compartments of the tray are formed in a v-shape that substantially matches the profile of the razor heads.

19. A razor package comprising:
at least two v-shaped razor heads, each having a cutting side and a posterior side and arranged so that one v-shaped razor head fits within a valley defined by another v-shaped razor head;
at least two plastic handles, each attached to one of the razor heads at a pivotable point midway along the posterior side of the razor head and arranged so that the handles extend parallel to one another from the v-shaped heads; and
a package configured to hold the v-shaped razor heads and the plastic handles in place.

20. A package of razors comprising:
a package having an anterior and a posterior side that defines a first slot, wherein the anterior side and the posterior side are joined by a side wall defining a second slot proximate the anterior side;
at least two v-shaped razor heads each defining a valley wherein one of the v-shaped razor heads fits within the valley of another of the v-shaped razor heads, and wherein the v-shaped razor heads extend through the second slot; and
at least two plastic handles each pivotably attached to one of the v-shaped razor heads, and wherein each handle extends through the first slot.
